(19) United States
(12) Patent Application Publication
(10) Pub. No.: US 2020/0038911 A1
(43) Pub. Date: Feb. 6, 2020

(54) LINEAR VIBRATION MOTOR

(71) Applicant: AAC Acoustic Technologies (Shenzhen) Co., Ltd., Shenzhen (CN)

(72) Inventors: Tao Zhang, Shenzhen (CN); Fanghua Ling, Shenzhen (CN); Jinquan Huang, Shenzhen (CN); Mengxun Shi, Shenzhen (CN)

(21) Appl. No.: 16/526,962

(22) Filed: Jul. 30, 2019

(30) Foreign Application Priority Data
Aug. 3, 2018 (CN) 201821255160.0

(51) Int. Cl. B06B 1/04; H02K 33/14; H02K 33/18; H02K 5/04

(52) U.S. Cl. CPC B06B 1/045; H02K 5/04; H02K 33/18; H02K 33/14

(57) ABSTRACT

A linear vibration motor includes a base having an accommodating space, a vibration system, an elastic member configured to fix and suspend the vibration system in the accommodating space, and a drive system fixed to the base and driving the vibration system to vibrate in a direction perpendicular to a horizontal direction. The vibration system includes a magnetic steel unit fixed to the elastic member and a first pole core stacked to the magnetic unit. The drive system includes a first coil and a second coil that are fixed to the base and stacked together in the vibration direction. Current directions of the first coil and the second coil are opposite. The magnetic steel unit surrounds the two coils and is disposed separately from the two coils. An orthogonal projection of the magnetic steel unit in a direction towards the drive system at least partially falls in the two coils.

### TECHNICAL FIELD

The present disclosure relates to a motor, and in particular, to a linear vibration motor applied to the field of mobile electronic products.

### BACKGROUND

With the development of electronic technology, portable consumer electronic products such as mobile phones, handheld game consoles, navigation apparatuses or handheld multimedia entertainment devices become increasingly popular among people. Linear vibration motors are usually used in these electronic products to provide system feedbacks such as call alerts, message alerts, and navigation alerts of mobile phones and vibration feedbacks of game consoles. Such wide application demands vibration motors to have excellent performance and long service life.

A linear vibration motor in related technologies includes a base having an accommodating space, a vibration system located in the accommodating space, an elastic member configured to fix and suspend the vibration system in the accommodating space, and a coil fixed to the base. Electromagnetic fields generated by the coil and the vibration system interact to drive the vibration system to make a reciprocal linear movement to generate vibration.

However, in a structure in which the linear vibration motor in related technologies vibrates in a Z-axis direction, a plane in which the coil is located is set to be perpendicular to a vibration direction, and the coil is disposed around a magnetic steel of the vibration system. Because there is one coil, a magnetic field that emanates from a bottom portion of the magnetic steel is generally used to cut the coil to generate a Lorentz force to perform driving, and a magnetic field from a top portion of the magnetic steel is not used. As a result, a drive system generates a limited driving force. That is, a force factor BL is small, and the vibration performance of the linear vibration motor is affected.

Therefore, it is necessary to provide a new linear vibration motor to resolve the foregoing problem.

### BRIEF DESCRIPTION OF THE DRAWINGS

FIG. 1 is a schematic structural perspective view of a linear vibration motor according to the present disclosure;

FIG. 2 is a partial schematic exploded structural view of a linear vibration motor according to the present disclosure; and

FIG. 3 is a schematic sectional view along a line A-A in FIG. 1.

### DETAILED DESCRIPTION

The present disclosure is further described below with reference to the accompanying drawings and implementations.

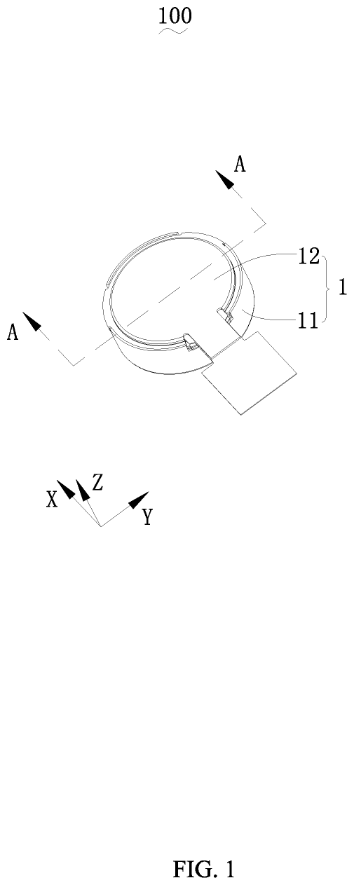

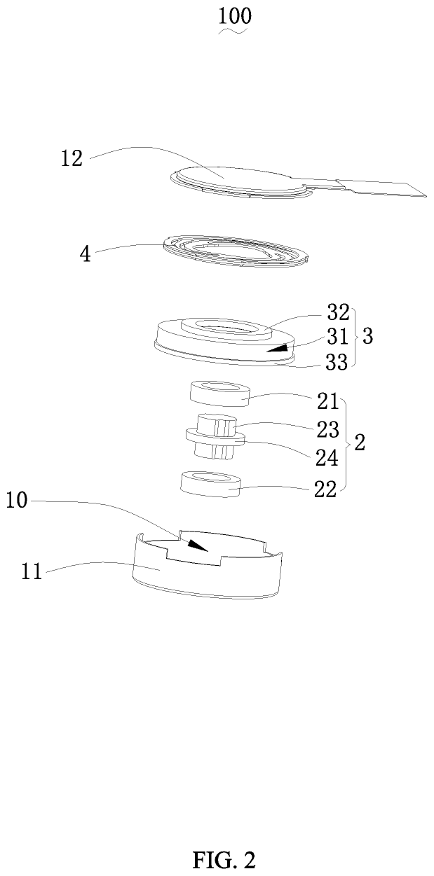

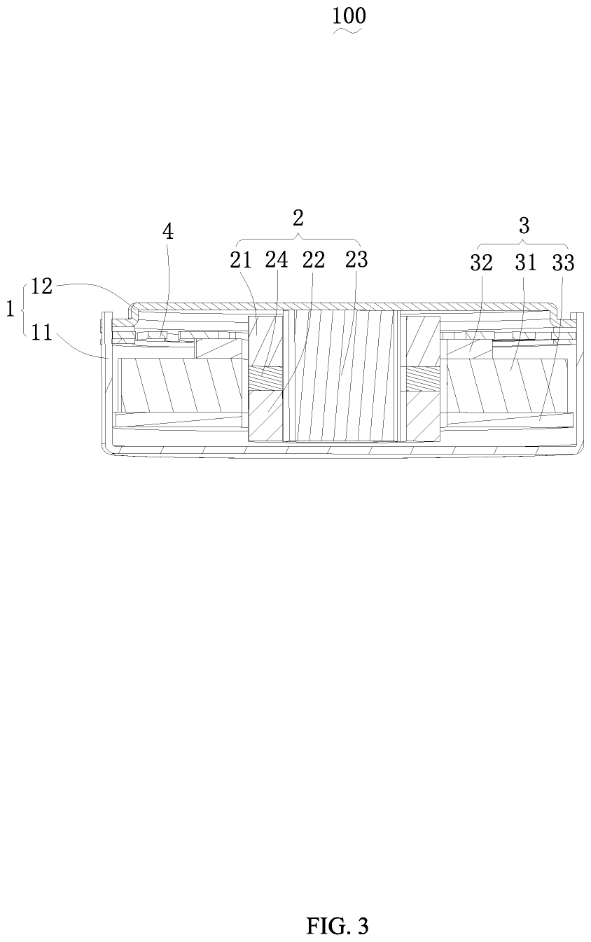

Referring to FIG. 1 to FIG. 3 together, the present disclosure provides a linear vibration motor 100, including a base 1, a drive system 2, a vibration system 3, and an elastic member 4.

The base 1 includes a seat 11 and a cover plate 12 covering the seat 11. The seat 11 and the cover plate 12 enclose an accommodating space 10 together. The base 1 may be an integral structure or may be a non-integral structure.

The drive system 2 is fixed to the base 1, and is configured to drive the vibration system 3 to vibrate in a direction perpendicular to a horizontal direction, that is, perpendicular to a plane formed of X and Y axes in FIG. 1, so as to generate vibration in a Z-axis direction.

In this implementation, the drive system 2 includes a first coil 21 and a second coil 22 fixed to the base 1 and stacked together, and an iron core 23 fixed to the base 1. The first coil 21 and the second coil 22 may be directly fixed to the base 1 or may be fixed to the base 1 indirectly through the iron core 23.

The first coil 21 and the second coil 22 are respectively fixedly sleeved over the iron core 23 and are located between the iron core 23 and the vibration system 3.

The iron core 23 is fixed to the base 1, for example, fixed to the seat 11. The iron core 23 is disposed to improve a magnetic conduction effect of magnetic fields to increase a driving force of the drive system 2, so that the vibration system 3 has a better vibration effect.

A plane in which the first coil 21 and the second coil 22 are located is perpendicular to a vibration direction of the vibration system 3.

It should be noted that the first coil 21 and the second coil 22 may be disposed separately or abutted against each other in an insulated manner. Moreover, the first coil 21 and the second coil 22 may be two independent coils or a two-coil structure formed by winding a same coil wire. Both cases are feasible.

In this implementation, the first coil 21 and the second coil 22 are disposed separately from each other, and a separation plate 24 is sandwiched between the first coil 21 and the second coil 22. The separation plate 24 is fixedly sleeved over the iron core 23. Specifically, a current direction of the first coil 21 and a current direction of the second coil 22 are opposite from each other.

The vibration system 3 includes an annular magnetic steel unit 31 fixed to the elastic member 4, and a first pole core 32 and a second pole core 33 respectively fixedly stacked on two opposite sides of the magnetic steel unit 31 in the vibration direction of the vibration system 3.

The first pole core 32 is located at a side, closer to the elastic member 4, of the magnetic steel unit 31. The second pole core 33 is located at a side, away from the elastic member 4, of the magnetic steel unit 31. The above-described structure makes the first pole core 32 and the second pole core 33 stacked on two opposite sides of the magnetic steel unit 31 respectively in the vibration direction of the vibration system 3, and applied to magnetization by using a point effect, thereby reducing magnetic field drain of the magnetic steel unit 31.

In this embodiment, a orthogonal projection of the first pole core 32 in the direction towards the drive system 2 completely falls in the first coil 21; a orthogonal projection of the second pole core 33 in the direction towards the drive system 2 completely falls in the second coil 22. That is, magnetization positions of the first pole core 32 and the second pole core 33 may enable directional magnetic fields respectively completely pass through the first coil 21 and the second coil 22. In this way, magnetization is realized to the extreme by using the point effect, thereby maximizing use of the magnetic fields.

The magnetic steel unit 31 surrounds both the first coil 21 and the second coil 22 and is disposed separately from the first coil 21 and second coil 22. An orthogonal projection of the magnetic steel unit 31 in a direction towards the drive system 2 at least partially falls in the first coil 21 and the second coil 22. The structure is disposed to enable horizontally divided magnetism on an upper side and a lower side of the magnetic steel unit 31 to respectively pass through the first coil 21 and the second coil 22 under magnetization of the first pole core 32 and the second pole core 33 to provide a Lorentz force, and the utilization of magnetic fields is high, so that a force factor BL is maximized, thereby effectively improving the vibration performance of the linear vibration motor 100.

It shall be noted that the magnetic steel unit 31 may either be one magnetic steel structure or a stacked structure formed by a plurality of magnetic steels in the vibration direction.

After passing through the first coil 21, the magnetic fields pass the iron core 23, and leave the iron core 23 to pass through the second coil 22 again. Because the current directions of the first coil 21 and the second coil 22 are opposite, Lorentz forces generated by the first coil 21 and the second coil 22 are in the same direction, thereby significantly improving the vibration performance of the linear vibration motor 100.

The elastic member 4 fixes and suspends the vibration system 3 in the accommodating space 10, to facilitate the vibration of the vibration system 3. Specifically, the elastic member 4 is fixed to the first pole core 32, thereby implementing suspension of the vibration system 3.

In this implementation, the elastic member 4 has an annular structure, and is fixed to a side, near the cover plate 12, of the seat 11.

Compared with related technologies, the vibration system of the linear vibration motor of the present disclosure includes the annular magnetic steel unit fixed to the elastic member. The drive system includes the first coil and the second coil that are fixed to the base and stacked together. The orthogonal projection of the magnetic steel unit in the direction towards the drive system at least partially falls in the first coil and the second coil. The structure enables magnetic fields generated by an upper side and a lower side of the magnetic steel unit to pass through the first coil and the second coil sequentially after the magnetic fields pass the first pole core and the second pole core and are magnetized to fully use the magnetic fields to increase a force factor BL. In this way, the utilization of the magnetic fields is high, so that a Lorentz force is increased, thereby effectively improving the vibration performance of the linear vibration motor.

The foregoing descriptions are merely preferred embodiments of the present disclosure but are not intended to limit the patent scope of the present disclosure. Any equivalent modifications made to the structures or processes based on the content of the specification and the accompanying drawings of the present disclosure, or directly or indirectly use the content of the specification and the accompanying drawings of the present disclosure in other relevant technical fields shall also fall within the patent protection scope of the present disclosure.

What is claimed is:

1. A linear vibration motor, comprising:
a base having an accommodating space,
a vibration system accommodated in the accommodating space,
an elastic member configured to fix and suspend the vibration system in the accommodating space, and
a drive system fixed to the base and configured to drive the vibration system to vibrate in a direction perpendicular to a horizontal direction,
wherein the vibration system comprises an annular magnetic steel unit fixed to the elastic member and a first pole core stacked to a side, closer to the elastic member, of the magnetic steel unit in the vibration direction of the vibration system,
wherein the drive system comprises a first coil and a second coil that are fixed to the base and stacked together in the vibration direction, a current direction of the first coil and a direction of the second coil are opposite from each other,
wherein the magnetic steel unit surrounds both the first coil and the second coil and is disposed separately from the first coil and second coil, and an orthogonal projection of the magnetic steel unit in a direction towards the drive system at least partially falls in the first coil and the second coil.

2. The linear vibration motor according to claim 1, wherein a projection of the first pole core in the direction towards the drive system completely falls in the first coil, and the elastic member is fixed to the first pole core.

3. The linear vibration motor according to claim 1, wherein the vibration system further comprises a second pole core stacked to a side, away from the elastic member, of the magnetic steel unit in the vibration direction of the vibration system.

4. The linear vibration motor according to claim 3, wherein a projection of the second pole core in the direction towards the drive system completely falls in the second coil.

5. The linear vibration motor according to claim 1, wherein the drive system further comprises an iron core fixed to the base, and the first coil and the second coil are fixedly sleeved over the iron core and are located between the iron core and the magnetic steel unit.

6. The linear vibration motor according to claim 5, wherein the drive system further comprises a separation plate fixedly sleeved over the iron core, and the separation plate is sandwiched between the first coil and the second coil.
